(19) United States
(12) Patent Application Publication
(10) Pub. No.: US 2002/0098465 A1
(43) Pub. Date: Jul. 25, 2002

(54) METHOD AND APPARATUS FOR TEACHING COMPUTER KEYBOARDING

(76) Inventor: JENNIFER ELSPETH SLADDEN, New York, NY (US)

Correspondence Address: DICKSTEIN SHAPIRO MORIN & OSHINSKY LLP, 2101 L STREET NW, WASHINGTON, DC, 20037-1526, US

(21) Appl. No.: 09/421,949

(22) Filed: Oct. 21, 1999

(51) Int. Cl. G09B 13/00

(52) U.S. Cl. 434/227

(57) ABSTRACT

A method and apparatus for teaching keyboarding utilizing a series of short exercises designed to present letter combinations, including word parts and whole words, that reflect both the keyboard organization, a frequent spelling combination and alphabet parts. A columns and alphabetic approach provides correct neuromotor patterning by establishing accurate brain-finger messages. The method may also be used with a technique for color-coding the fingers on each hand and their associated keys on the keyboard to provide visual stimulus to further enhance the learning process.

### BACKGROUND OF THE INVENTION

1. Field of the Invention

The present invention relates generally to a method and apparatus for teaching keyboarding. More particularly, the present invention relates to a method and apparatus for teaching users how to develop keyboarding fluency through a multi-sensory approach that generally begins by teaching the key locations of all the letters in the alphabet. This approach optimizes fluency development by centering the user's fingers over certain keys, which enables the user to take advantage of various letter patterns that exist on the keyboard. Fluency development is enhanced when a coach guides a user throughout the learning process. This approach also enables users to integrate keyboarding skills into the generative writing process and to use the keyboard in an ergonomic manner.

2. Description of the Related Art

Teaching keyboarding has become critical in light of recent developments. The most significant are:

(a) Increasing use of the computer and thus the keyboard as the principal writing tool;

(b) Increasing use of electronic media as the principal method of written communication;

(c) Migration from the linear process used when writing by hand to the multidimensional one used when writing by keyboard; and

(d) Health risks associated with improper use of the keyboard and poorly designed computer workstations.

Thus, people of all ages would benefit by developing keyboarding fluency.

Correct neuromotor patterning is critical to keyboarding fluency. Thus, the user must be taught to develop cognitive awareness of the messages the brain receives from the fingers and to integrate those messages through visualization (i.e. to develop the “mind's eye”). However, there has been little research into the effective teaching of keyboarding or use of keyboards. Existing teaching methods largely were designed before the advent of the computer keyboard and were directed at typewriter technology; they are not appropriate for today's computer technology. Moreover, most teaching methods rely on rote practice, i.e. memorization exercises, and lack any cognitive awareness or sensory integration training. These methods cause a user to progress slowly through numerous repetitive lessons. The lessons do not take into account relevant behavioral principles (especially for a user who is risk averse or fearful of failure) and thus do little to motivate or to encourage perseverance. Nor do existing methods take into account relevant ergonomic principles and thus the existing methods do little to promote ergonomic use of the keyboard. In some instances, the existing methods teach potentially injurious keyboarding habits.

Developments in the art focus on improvements such as changing the layout of the keyboard to enable the user to key faster. Other improvements have identified a set of key hand/arm movements that enable the user to key more efficiently.

Existing self-directed typing programs employ the home-row method that requires that the user concentrate on the location of each key in a row-based sequence, one key at a time. That method teaches first the letters located in the middle row of keys (ASDFGHJIKL). This row of keys represents a meaningless set of letters relative to how the keyboard is organized and how the writing process works. Only after this row of keys has been learned does the home-row method add the rest of the keys, one at a time, through a series of rote practice exercises. At no time is the user taught to focus on the material being keyed or on one's thought processes. The exercises take a long time to complete successfiilly since the user is required to achieve a defined accuracy and target speed with each exercise before progressing to the next one. A user must persevere through numerous lessons before s/he can begin to understand how the keyboard is organized, experience the process of writing through the keyboard and/or integrate this new skill into the generative writing process. For example, punctuation typically is taught at the end of the program. Moreover, existing methods do not teach users how to develop metacognitive awareness of correct fingering and physical alignment with the keyboard through kinesthetic and mental imagery (rather than through looking at his/her hands). Nor do existing methods take into account the need to teach the keyboarding instructor how to train and monitor users.

Additionally, these programs do not stress ergonomics. Consequently, certain users may develop poor habits that can potentially lead to injury. The importance of teaching ergonomics and correct use of hands, fingers and body alignment has become critical in light of the current research into repetitive stress injury (RSV), such as tendinitis, carpal tunnel syndrome, cysts bursitis, to name a few.

Typing tutor or “edutainment” keyboarding software games are not appropriate for teaching the habits and core techniques of sound keyboarding. These standardized programs cannot accommodate users' disparate learning styles, which are affected by factors such as motivation, age, abilities and disabilities—both at the physical and cognitive levels. Sound keyboarding is predicated on the user “learning how to learn.” For a younger user, learning how to learn means simultaneously integrating the mechanical process of writing (input) with thought (content) and the organization of ideas (organization). For the older user, learning how to learn may already have been achieved and, consequently, that user's focus may be directed to developing mechanical keyboarding fluency commensurate with existing language-related skills.

Thus, there is a need in the art for a flexible program that:

(a) Breaks down learning into its components;

(b) Enables the learner and the teacher to tailor keyboarding to the specific needs—abilities and disabilities—of the user; and

(c) Incorporates relevant elements of traditional methodology with current computer technology attributes to engage users in a multi-sensory learning process.

More particularly, what is needed is a methodology that identifies the discrete components comprising the learning process. The learning process can be described as the sum of two interdependent layers, namely the cognitive layer and the motoric layer. The present invention embodies this construct—sensory integration of the cognitive and motoric layers is critical to successful keyboarding. While the mechanical practice and visualization teach the skills necessary to keyboard, cognitive processing is integrated through the recognition of important patterns and their practice within the context of generative writing.—Thus, it teaches the user how to integrate one's cognitive processing with one's motoric activity to generate computer-based writing. The computer screen presents writing as a patterned progression that invites reorganization and helps clarify thought. Thus, the focal point of computer-based writing becomes the quality and progression of the content, not the accuracy of the spelling. Handwritten and typewritten work can be cumbersome to review and time-consuming to revise. Keyboarded work displayed on a monitor is easier to review, manipulate and revise. Errors such as illogical arrangements are easier to identify and faster to revise. These attributes facilitate not only generative writing and but also significant rewriting.

While keyboarding is a useful skill for all that desire to improve their ability to document information and to communicate with others, it has become an essential skill in many sectors of society. Included are people who have difficulties with (1) handwriting, (2) vision, (3) organization; (4) language, (5) sequencing or mapping; (6) the mind working faster than the body; and (7) those with physical disabilities. The present invention anticipates the needs of users having these kinds of difficulties, including single-handed, visually impaired and learning disabled users.

### SUMMARY OF THE INVENTION

The present invention overcomes the problems associated with the prior art, provides a unique method for teaching keyboarding and adopts a comprehensive methodology for learning keyboarding that transcends the above-noted developments.

The present invention is a unique keyboarding method that is adaptable to a wide range of user requirements. It consists of an intellectually engaging language-based sequence (versus an arbitrary home row sequence). It starts with the entire keyboard layout taught in the context of the 26-letter alphabet sequence. It then progresses immediately to generative writing through scaffolded writing (word production) techniques and assistive technology (such as important cap accessories and color-coded visual aides). An alphabet song, poem or rap (depending upon age and preference) integrates verbal labels for all the important motor actions needed to keyboard fluently and serves as a powerful mnemonic to remember key location. Once users have learned the alphabet, they can accurately keyboard anything (albeit slowly), which is tremendously motivating. The subsequent stages of this approach consist of various exercises that interest and motivate children and adults to establish correct fingering as they inculcate understanding of the overall spatial organization of the keyboard.

The present invention is based upon the belief that correct neuro-motor patterning is critical to fluency. In this case, for example, the message from brain to finger to glide up the CDE staircase in a diagonal line with just the middle finger must be consistent and correct from day one so that opposing messages do not impair the automatic habit. (This staircase concept is related to all the keys and their associated fingers.) If a user is allowed to sometimes use the wrong fingers for the CDE move, the brain becomes confused and sends alternating messages in response to the cognitive command to keyboard the CDE staircase. The present invention provides a different emphasis to that of the prior art by developing awareness of brain finger messages and visualization to develop the “minds eye” for remembering letters in the context of syllable patterns by feel, mental imagery, and pattern recognition. This is particularly applicable to single-handed and low vision students.

The system integrates learning to copy with word processing techniques and emphasizes the power of generative writing as a way to build fluency and integrate newly learned keyboarding skill into everyday use. Moreover, the present invention focuses upon a learning process that facilitates the acquisition of key location while also addressing sensory motor integration required for keyboarding. Users move beyond the single finger/letter association and learn frequent letter patterns. From the start, this program establishes three different writing modes: (1) looking at the monitor, for functional writing; (2) looking at printed text, for transcription writing; and (3) looking without a focal point for free-form thinking such as brainstorming (during which time the user's thoughts can flow uninterrupted by functional tasks such as editing), for generative writing.

This system emphasizes accuracy and good habits while developing the mind-body consciousness essential to learning a new motor skill. Helping users become aware of the visual-motor sensation of their fingertips (i.e. their kinesthetic sense) helps them filter out dominant visual inputs that cause them to look at their fingers. It also helps them compensate for weak finger recognition, poor fine motor coordination and low vision.

The aforedescribed two layers are found in the instant invention through three lesson modules: the orientation exercises module, the introductory sessions module and the extreme lessons module. The orientation exercises module gives users everything that is needed to develop keyboarding fluency and teach the full keyboard, via the alphabet, in one to three hours (depending on ability, disability, age and motivation). The introductory sessions and extreme lesson modules provide further practice necessary to reinforce the instruction and assure sensory integration and fluency. The introductory sessions modules give users the practice to drive integration layers home in a focused way because each lesson isolates a pattern that will pre-empt error by introducing motor patterns that reflect frequent spelling sequences. More importantly, experience has taught that fingering requirements for keyboarding involve certain patterns, which result in repetitive errors due to hand structure and keyboard layout. These common patterns are integrated into ultimate word generation. From the word generation, the user then goes into copying sentences that are provided to him/her. The user is then instructed to write generatively. The process is a progression from a part to a whole—commonly found patterns are extended into simple and multi-syllable words. These patterns were developed by observation of the layout of the keyboard and of how certain patterns on the keyboard reflect alphabet sequences and commonly used syllables. It has been reinforced in part from Margaret Standback's book “Syllable and Rime Patterns for Teaching Reading: Analysis of a Frequency Based Vocabulary of 17,062 Words.” Annal of Dyslexia Vol. 42 1992, P.196-221.

These and other advantages and features of the invention will become apparent from the following detailed description of the invention, which is provided in connection with the accompanying drawings.

### BRIEF DESCRIPTION OF THE DRAWINGS

FIG. 1 illustrates a QWERTY keyboard showing the keys that are assigned to each finger as well as making the diagonal arrangement (staircases) of the letter keys explicit;

FIG. 2A illustrates a black and white version of a staircase color-coding scheme for two handed keyboarding in accordance with the present invention;

FIG. 2B illustrates in color the color-coding scheme as depicted in FIG. 2A;

FIG. 3A illustrates in color a color-coding scheme for left handed only keyboarding;

FIG. 3B illustrates in color a color-coding scheme for right handed only keyboarding;

FIG. 4 illustrates a block diagram overview of the computer system of the present invention;

FIGS. 5A & 5B illustrate flowcharts of the input module of the computer program of the present invention;

FIG. 6 illustrates a flow chart of the orientation exercise module of the computer program of the present invention; and

FIG. 7 illustrates a flow chart of the orientation exercises of the computer program of the present invention.

### DETAILED DESCRIPTION OF THE PREFERRED EMBODIMENTS

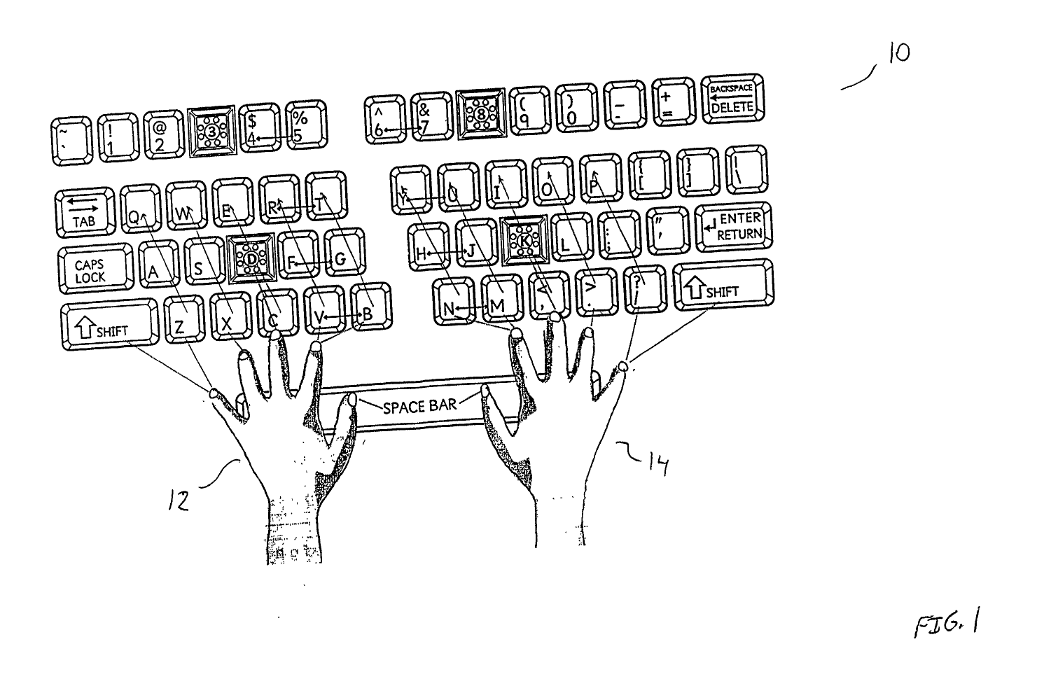

The present invention will be described as set forth in the preferred embodiment illustrated in FIGS. 1-7. Other embodiments may be utilized, and structural, logical, or programming changes may be made, without departing from the spirit or scope of the present invention.

The following terms will be used:

Centering: Centering describes correct posture, consistent body alignment relative to the computer workstation and use of raised sensors for locating middle finger centers (default positions). Centering helps users develop awareness both of the position of their body in space and the organization of the keyboard, through a consistent spatial relationship between their fingers and the keyboard. In the prior art, these concepts are taught at the beginning. Users receive no further instruction, reinforcement or feedback regarding alignment and fingering. This void is particularly harmful to users who have visual-spatial cognition difficulties. Ongoing support from a trained “coach” and/or establishment of a system that is based on a user's metacognitive ability fills this void.

Staircases: Staircases describes the arrangement of certain keys (diagonal lines ZAQ XSW EDC), each of which corresponds to a particular finger to establish consistent fingering patterns so that the user does not have to look at their fingers. Indeed, this system addresses the problem of students who need to learn to use their verbal memory rather than the visual. If these students depend upon visual feedback for finger-key placement by looking at their hands on the keyboard, the strongest fingers (Middle and Pointer) take over. It is assumed that the need to use each finger consistently for the same set of keys is essential for developing the ability to “touch-typing” or “kinesthetic keyboarding.”

Shoulder movement: Shoulder movement describes movement from the shoulder executed by keeping the wrists slightly raised above the wrist rest and achieved as a result of correct posture, alignment and staircase fingering technique. The Pinkie and Ring finger moves are hard because of the shortness of the Pinkie and the lack of independence found in the Ring finger. This latter problem arises from the fact that the Ring and Middle fingers share tendons and nerves causing the middle finger to have become the dominant finger through evolution. This is a novel factor in the keyboarding literature. The awkward stretches of the pointer to b and y also cause an alignment problem. When making the moves described above using only finger movement, the student has to torque the body or kink the wrist in undesirable ways.

Coaching: Coaching describes the teacher's role in helping users develop awareness of key concepts, in drawing attention to users' application of those concepts and in providing ongoing feedback to users as they work through the sequences.

Before the teaching of any exercises, users are presented with concepts related to working with a computer. Items such as the position of the computer in a room, the necessity of sufficient and well-organized space around a computer, and the position of the workstation are taught. For example, the average ground area required for a computer is approximately foursquare meters, which allows room for two people to be working at the station. The workspace must be of sufficient size to allow a mouse to be used efficiently. It must also provide the lower arms with a rest on the desk in front of the keyboard or some other device used to support the wrists while resting and to prevent kinking at the wrist. In addition, the position of the user's body in relationship to the computer and the position of other files and necessary tools for work are taught. The top of the screen should be close to eye level, with the nose opposite the middle of any text on the screen.

Additionally, concepts related to proper body posture are presented to the user. The correct posture is critical to fluent keyboarding and long-term health. The wrists of the user should float so that the hands may move freely over the keyboard rather than moving each finger separately from the knuckles. The shoulders and neck need to be relaxed with a straight back (balanced but not fixed). The forearms must be at right angles to the upper arms when using the keyboard. A wrist rest will prevent the wrists from dropping out of line, but the wrists should float freely while keyboarding. There should be some movement from the shoulder to prevent repetitive stress injury caused by having the fingers do all the work. A stable but dynamic base is required: the upper legs should be horizontal and the feet should be flat on the floor. Copy material should be within peripheral vision so as to prevent twisting the body. This also aids accuracy and visual tracking.

Body posture and positioning is in contrast to pressure-based “speed” approach (e.g. clock-driven exercises) used by other typing teaching methods. In those approaches, tension results. In the present invention natural fluency is emphasized. The first few hours of keyboarding instruction are more important than which kind of keyboard or which typing program is used. Success leads to success and motivation to practice which, as fluency is achieved, the optimal speed for a particular student will emerge. Just as a runner gets “into a groove”, depending upon the distance of the race, keyboarding fluency is reached when the user has achieved relaxed automatic fingering which includes a rhythmic body awareness.

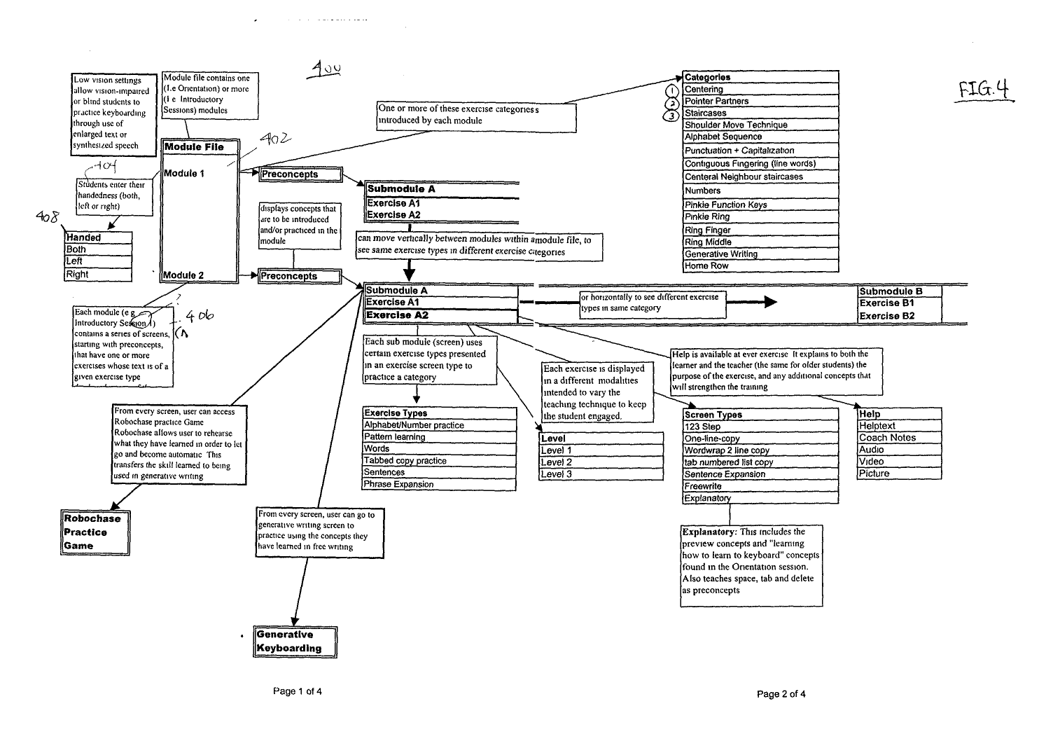

The user is then introduced to the computer program 400 which has the overall organization as set forth in FIG. 4. The details of each module in the computer program are shown in the subsequent Figures and are described below.

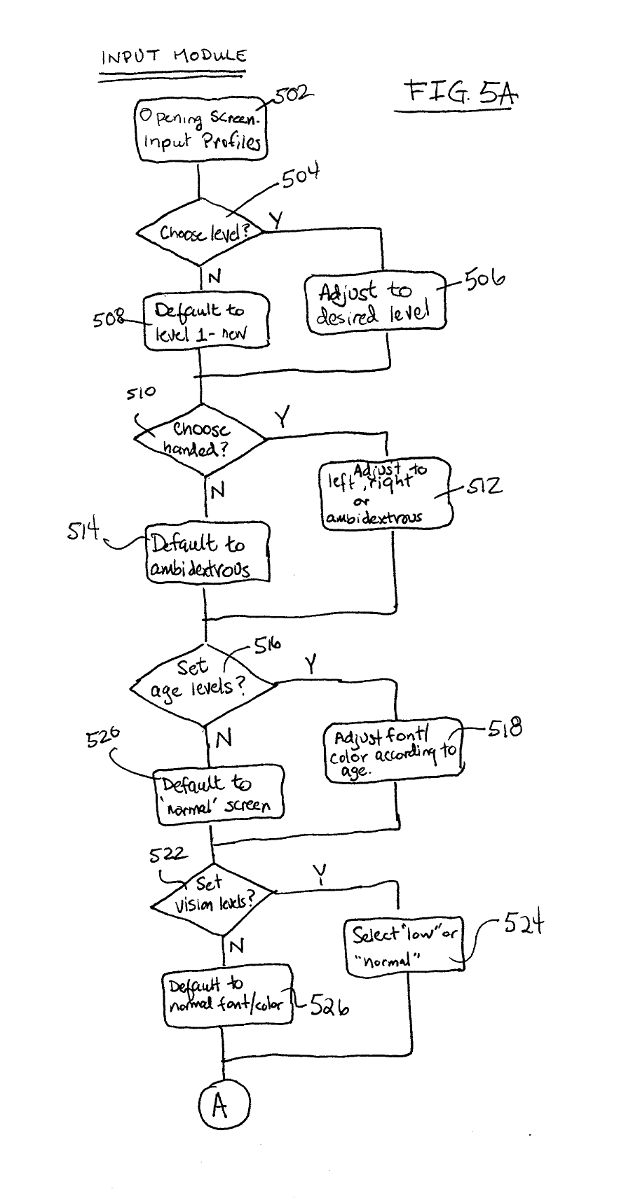

FIGS. 5A & 5B illustrate the input module 500 for the computer program. The purpose of the input module is to set up or modify a user's profile. The module may be entered once, the first time a user enrolls, or many times, such as when modifications are needed every time the user uses the program or even multiple times while the program is being used.

The opening screen for the program gives the user a choice of either creating a new profile, changing an existing profile setting or slipping over the input module altogether. If either the “change” or “enter” selection is made then the program goes to step 504 which asks the user (or teacher) if they wish to adjust the level of the program. If the answer is “yes” then the user is asked whether they want to adjust to one of three levels. Activation of each of the level choices causes the underlying exercises to be modified to a higher speed, to involve more complex exercises, and be presented in different sized fonts.

The underlying exercises can be changed on the fly as well. During the course of a computerized exercise a user or teacher may want to modify an existing exercise or add a new version of an exercise altogether. Additionally, the level of difficulty of an exercise can be changed on the fly. This allows the computer program to be tailored to the individual user who may, for certain exercises, have a skill above the pre-ordained level, while for other exercises be at or below the chosen level.

Returning to step 504, in the event that the user does not want to add or change a level, then the default level 1 is chosen for a new profile at step 508. For an existing profile—the pre-existing level is maintained.

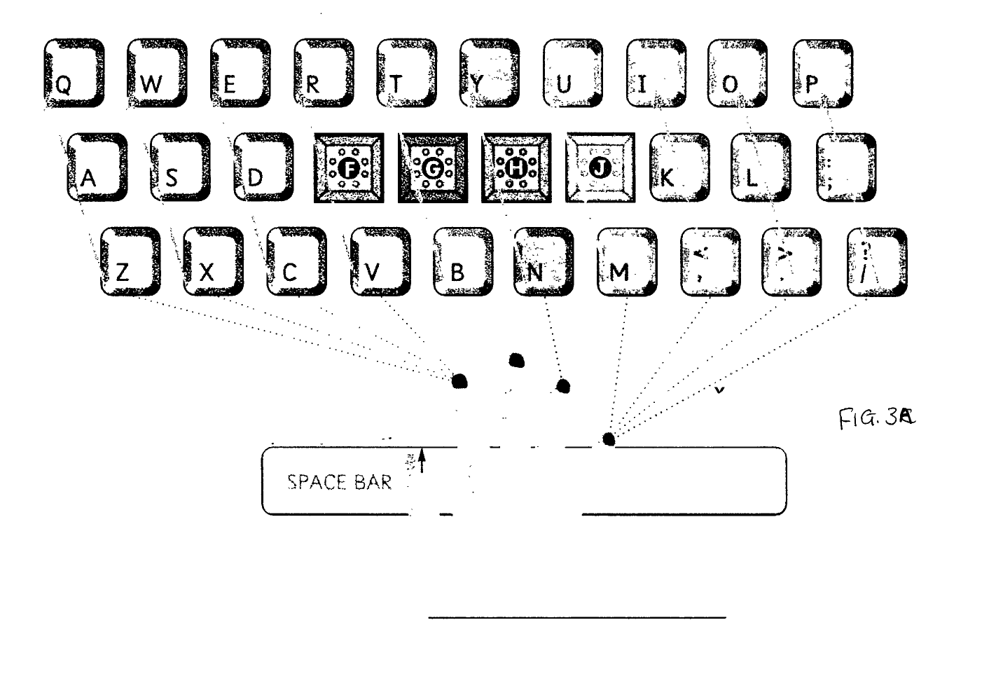

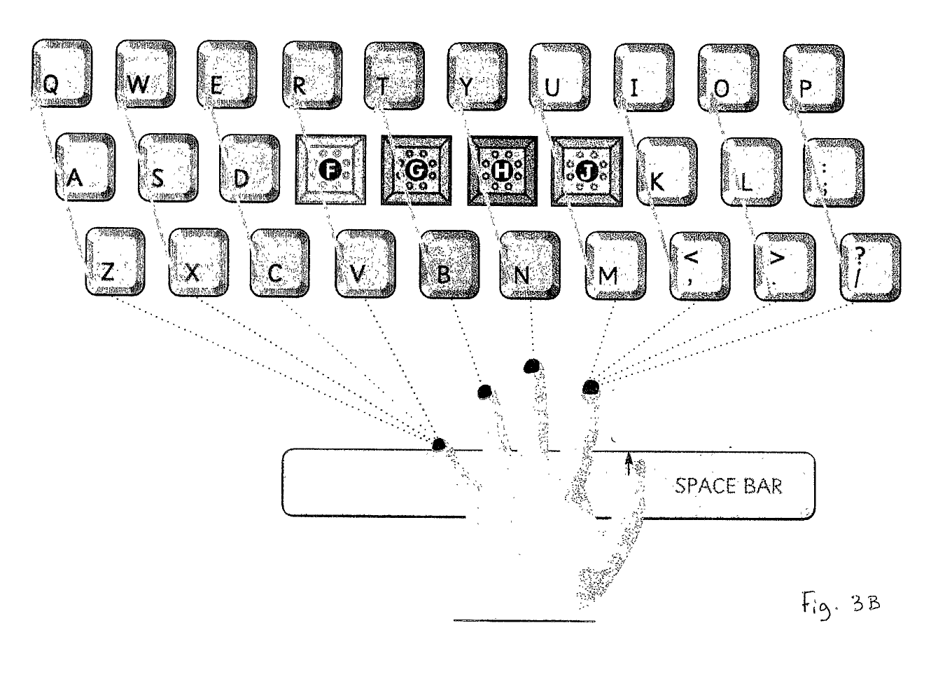

Step 510 allows the single-handed orientation to be chosen. There are basically three orientations, one for users who have one functional left hand, another for users who have one functional right hand, and a third for users who are ambidextrous. The choice for the orientation is then made at step 512. Once the choice of orientation is made, the keyboard exercises are then altered to reflect the orientation chosen. The overall organizations of the chosen keyboards are illustrated in FIGS. 3A & 3B.

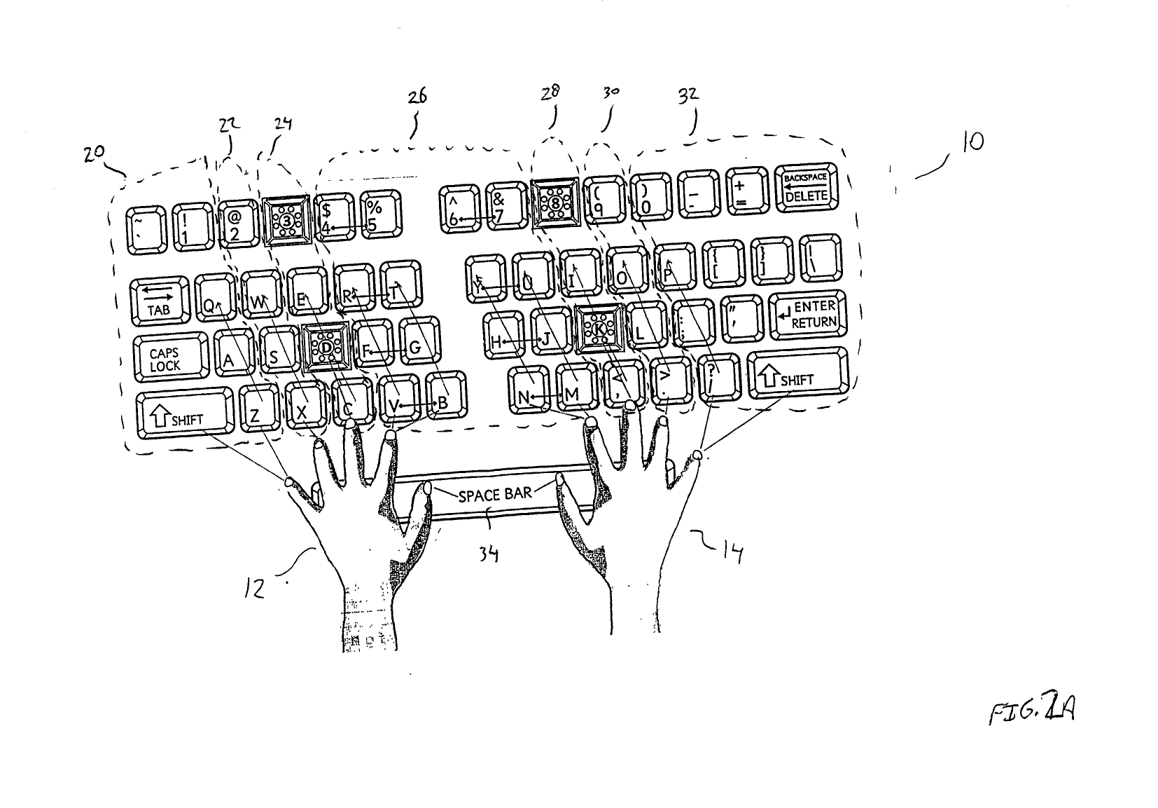

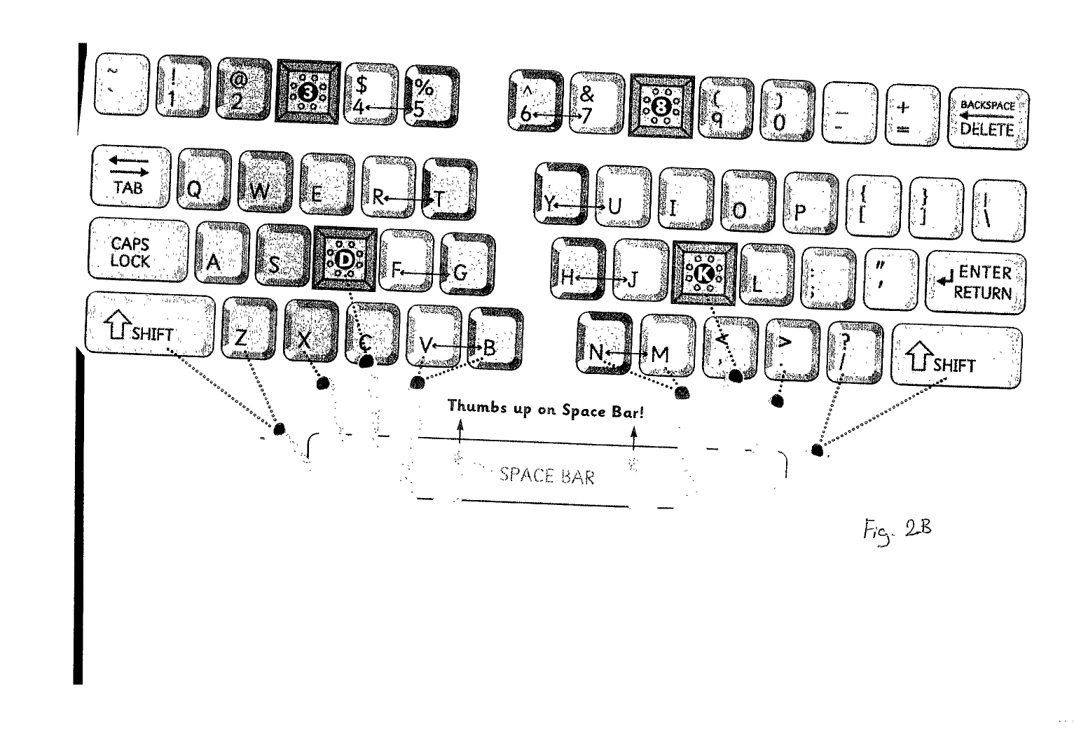

For example, if in step 512 the left handed orientation is chosen, then the keyboard fingering to be taught is illustrated in FIG. 3A. All exercises are then modified accordingly. If on the other hand, the user is a single handed right-handed user, then the lessons are altered to reflect the keyboard shown in FIG. 3B. If neither orientation is desired, then the system defaults to ambidextrous at step 514—i.e. two-handed use, and the keyboard shown in FIGS. 2A & 2B is used in the exercises.

At step 516, the user is asked about the age level setting. Although there are many possible ways to alter the program based on age, for the present embodiment the font size and color of the screens can automatically change based on age at step 518. For example, in the preferred embodiment, the font used for a child in grades one through three may be larger than the one used by a child in grades four through eight. Moreover, color contrast for the younger child may be a lot greater than as the child gets older. The user may also customize font and color contrast manually at step 518.

If the age choice is of no interest (in which case the old setting will remain) or if the user wants to go to a default setting, then the default will go to the standard font size and color setting at step 520. In the preferred embodiment the default font and color is set at the adult level (9^{th} grade and up).

The user profile can then set the vision level at step 522. There are two setting options: low or normal step 524. If the low setting is offered, then the font size is increased and the contrast colors are used in the screen displays (e.g. yellow and black). If no level is chosen then the normal setting remains at step 526, or the existing setting is kept in the profile.

Referring now to FIG. 5B, the last request in the profile is the answer to the question on colorblindness, step 528. If the answer is “yes” then the colorblind setting is selected and the color scheme is altered at step 530. Otherwise, the normal color settings are kept as the default setting at step 532. The input module ends at step 534.

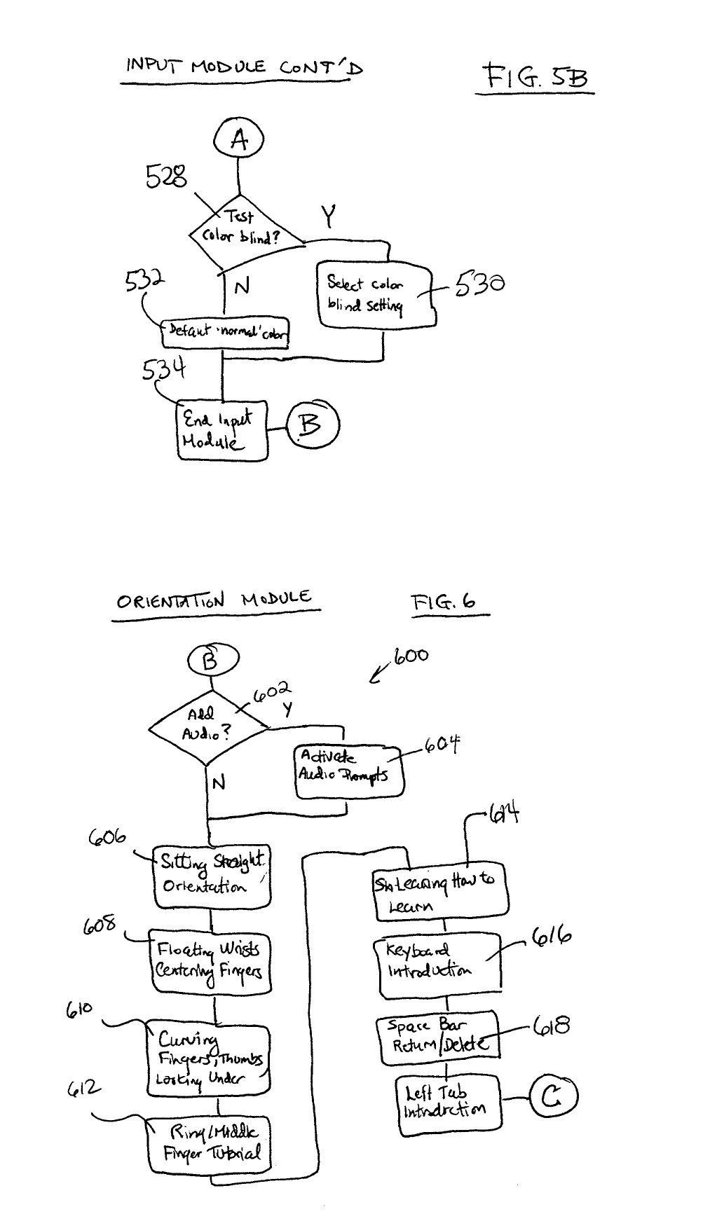

The next module is the orientation module. The purpose of this module is purely explanatory—to develop an understanding by the user of the correct positioning and movement associated with keyboarding. The computerized orientation module is shown in FIG. 6 as module 600. The orientation module begins at step 602 with a query as to whether or not the user wants to add audio to the exercises. If the response is affirmative, then at step 604, an audio description of all the exercises is activated. For those users who have poor vision, or who need verbal reinforcement, the audio feature provides voice-based encouragement and information about the ensuing exercises to that user.

The descriptive portion of the orientation module begins at step 606. The portion of the module provides the user with information on how to position the body at the workstation. In particular, the module stresses the importance of the screen placement relative to the eye level as well as the user's nose. The user's shoulder and neck must be relaxed with a straight back and the forearms must be at right angles to the upper arms. There should be a stable and dynamic base so that the user's upper legs are horizontal with the feet lying flat on the floor. At step 608 the user is provided with information regarding the floating wrist position. As noted previously, the floating wrists posture is critical to the correct hand posture for the present invention. Some graphical information is provided in this step to illustrate to the user how to place the wrists relative to the wrist rest and keyboard. At step 610, information on the position of the fingers and the curve of the hand is provided. The correct curve of the hands is established by placing the thumbs squarely on the space bar. Additionally, the user is discouraged from looking under the fingers to determine where on the keyboard their hands are located. In this step, the user is also provided with an introduction to the physical characteristics of hands relevant to keyboarding. It is critical for the user to learn the names of his/her fingers because part of the keyboarding instruction is tied to particular fingers and because these verbal labels are used throughout the exercises and in a song/rap/poem/mnemonic.

At step 612, information in the form of a tutorial is provided regarding the anatomy of the ring and middle fingers, specifically that they share nerves and tendons. Messages from the brain to these two fingers, therefore, can become confused. Several exercises are used to illustrate this confusion and to help differentiate the fingers.

Step 614 provides the user with information regarding learning how to learn through a three-step visualization procedure. (Insert e-mail) At step 616 the keyboard is introduced. As part of the introduction, the keyboard is presented graphically to the user with an illustration of the key coloring map. Specifically, the user is provided with a graphical display of and an actual keyboard for typing with visual aids located on the keyboard to reinforce the concept of each finger of each hand being used to depress specific keys of its corresponding staircase. To accomplish this objective, the keys on the keyboard are displayed as being color-coded while the actual keys use self-adhesive removable color-coded “staircase” keycaps. Each color-coded keycap is printed with the symbol found on the key that is covered. Additionally, some of the keycaps may be shown and provided with texture, such as bumps or a ring for example, to provide touch perception by the fingertips to help aid in proper placement of the fingers. The fingernail of each finger corresponding to the color-coded keys is similarly color-coded by self-adhesive removable dots.

The color-coding may be achieved by using a small colored dot adhered to each fingernail, nail polish or any other method desired. The pinkie finger of each hand is color-coded green, the ring finger of each hand color-coded purple, the middle finger of each hand color-coded blue, the pointer finger of each hand color-coded red and the thumb of each hand color-coded yellow.

The color-coding of the keys on the keyboard may be achieved in a similar manner. The staircase keys that are depressed by the pinkie fingers are color-coded green, the staircase keys that are depressed by the ring fingers are color coded purple, the staircase keys that are depressed by the middle fingers are color-coded blue and the staircase keys that are depressed by the pointer fingers are color-coded red. The spacebar, being the only key depressed by the thumbs, is color-coded yellow.

Thus, as shown in the FIG. 2A example, keyboard 10 is color-coded in the following manner. Those keys that are depressed by the pinkie finger of the left hand 12, designated by the area within dotted line 20, and those keys that are depressed by the pinkie finger of the right hand 14, designated by the area within dotted line 32, are color coded green to match the color coding of the pinkie finger on each hand. Those keys that are depressed by the ring finger of the left and right hand, designated by the area within dotted lines 22 and 30, respectively, are color-coded purple to match the color coding of the ring finger on each hand. Those keys that are depressed by the middle finger of the left and right hand, designated as the area within dotted lines 24 and 28, respectively, are color-coded blue to match the color coding of the middle finger on each hand. Those keys that are depressed by the pointer finger of the left and right hand, designated as the area within dotted line 26, are color-coded red to match the color coding of the pointer finger on each hand. The space bar 34 is color-coded yellow to match the color coding of each thumb. FIG. 2B illustrates in color the above-described color-coding scheme.

Additionally, those keys that are depressed by the pointer fingers may be color-coded with different shades of red to further define that the pointer finger on each hand depresses two separate staircases. The different shades of color differentiate between the pointer and the partner keys. For example, keys VFR4 and MJU7 may be a lighter shade of red than keys BGT5 and NHY7 to differentiate the staircases.

The use of finger and staircase key color-coding provides the user with instant visual feedback concerning the use of the proper finger to depress a certain key. While a specific color-coding scheme has been described, the invention is not so limited and any combination of colors may be used. In addition, the color-coding may also be used with the method for teaching single handed keyboarding as illustrated in FIGS. 3A and 3B.

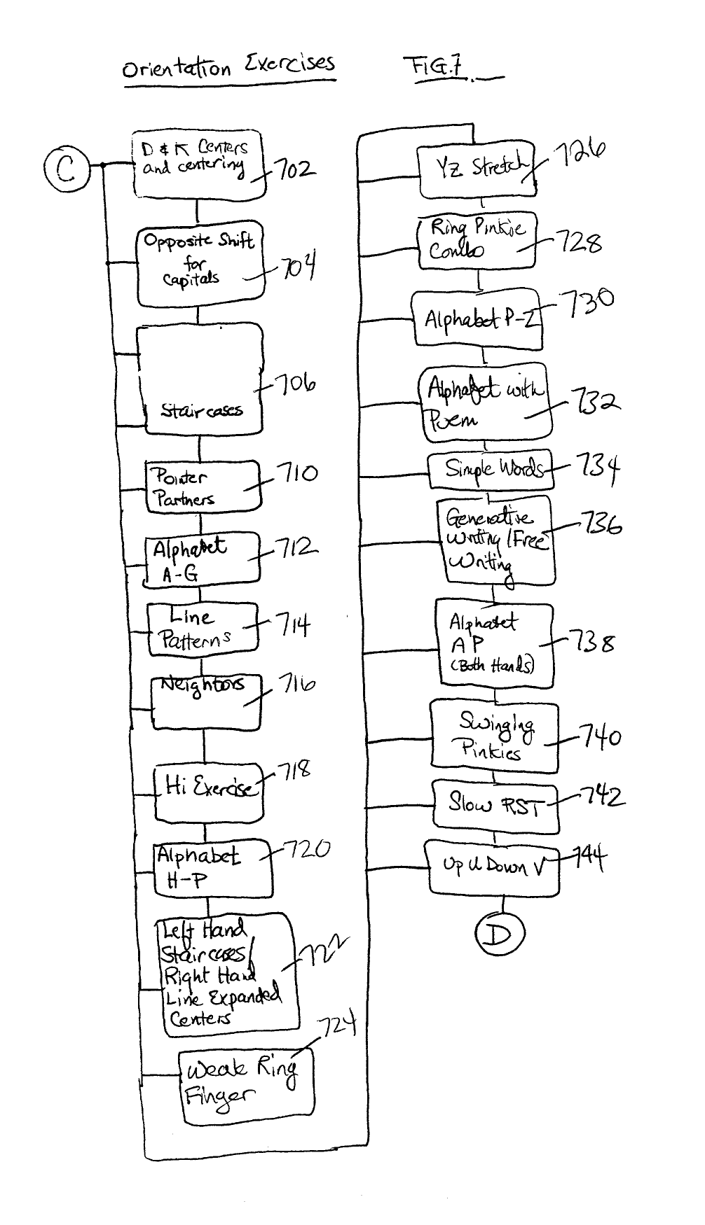

As shown in FIG. 7, the first set of exercises is the orientation exercises. The orientation exercises employ a sport training parallel to ensure that only correct habits are practiced through training (as opposed to drilling). The orientation exercise enables the user to anticipate and preempt errors by developing a finger/keyboard awareness and dexterity. In order to efficiently keyboard, a user must first become familiar with the location of the keys by learning the location of the function keys and the alphabet on the keyboard.

Returning to FIG. 6, and following the keyboard introduction, the user is oriented to the space bar and the return key at step 618. The screen display at this step prompts the user to place his/her thumbs on the spacebar so that the thumbs are pointing towards the top of the keyboard insuring the correct curve of the hand, so that the fingertips, and not the finger pads, strike the keys. The user is then asked to tap the spacebar several times and watch the cursor move on the computer screen. The little fingers are then used to press both the enter and backspace keys.

An orientation is then given for the use of the pinkie fingers. First, the delete and backspace functions are introduced. Then, the use of the left pinkie for the tab key and the right pinkie for the return or enter key at step 618 are introduced.

The user proceeds to a series of exercises that teach the letter and number keys, which will be described below.

The method according to the present invention provides a series of short exercises. Each exercise presents letter combinations, including word parts and whole words, which reflect both the keyboard organization and a frequent spelling combination. Each exercise also connects the existence of alphabet sequences to the keyboard (the latter of which will be identified by the designation “AS”). The fluency of reciting the reemphasized alphabet in these exercises is carried over into a motivation to translate this verbal fluency into the mechanical expression of typing. Such fluency is made accessible by breaking down the alphabet into sections that also address the concepts being taught. The principles of the invention are embodied in computer software, and can be combined with assistive technology that is used in conjunction with the computer software, as further described below.

As shown in FIG. 7, the first orientation exercise is the D & K centers exercise at step 702. The underlying organization/finger placement themes in accordance with the present invention are centers D and K for the middle fingers. Placement of the middle fingers at the D and K centers enables the other fingers to also be correctly placed in relationship to their staircase/columns. Correct placement facilitates the user learning which fingers are to be used for which keys. These centers are extended to a left and right hand alphabet string that in turn teach the difference between the fingering for a staircase CDE (the concept of the staircase will be discussed below) versus a horizontal string (JKL). FIG. 1 illustrates a typical Qwerty keyboard 10.

In the previously discussed home row method, the default positions for the four fingers of each hand (excluding the thumbs) are the horizontal row of keys: ASDF for the left hand, and HJKL for the right hand. The fingers rest on the default position keys except when the user extends the fingers to use other keys.

By contrast in the present invention, the middle finger of the left hand 12 has D as its center (default) position and the middle finger of the right hand 14 has K as its center (default) position. The middle fingers touch their respective keys (D and K), however; the remaining fingers do not rest on any keys. This enables the user to reach and use the various keys by initiating hand and thus finger movement from the shoulders. Consequently, the user does not have to extend any of his or her fingers to keyboard. The benefits of this approach include pre-emption of the errors and difficulties most users have when attempting to move the ring finger independently. For example, users tend to substitute a dominant middle finger for the ring finger.

The exercises that follow each contain a set of three letter sequences. These sets represent three levels of learning.

[1] The exercises for D and K centers permit the user to focus on learning procedure and/or how to use the software in addition to the location of the letters on the keyboard. A three step visualization procedure, a methodology used throughout the modules, is employed so that users can learn the positions of the keys without looking at the keyboard. In the first step, the user is asked to look at the keyboard while performing the exercise and to make a mental picture of the letters being keyed and the corresponding finger motion. In the second step, the user is asked to look at the monitor and say aloud the letters being keyed. This step enables the user to begin integrating the auditory, visual and kinesthetic senses. In the third step, the user is asked to close his/her eyes and visualize the fingering pattern as s/he keyboards it. After the user has completed the three-step procedure for a given exercise, the user advances to a practice game to reinforce what has been learned and ultimately to develop keyboarding fluency. The exercises designed to teach the letters D and IK, include the following sequences:

DDD KIK Centers

(1) ddd kkk ddd kkk

(2) dk dk dk dk

(3) ddd kkk ddd kkk ddd kkk

[2] The next set of exercises teaches that the opposite shift is used when making capitals found at step 704. This set is used for teaching capitalization and the “!” and “?” keys. To produce a capital letter, the pinkie of the hand not being used to key a letter presses the shift key. The position of the pinkies in relation to the keyboard is discussed with the user. The right pinkie naturally rests around the “/?” key whereas the left pinkie naturally rests on the left Shift key. Attention is drawn to the fact that the left pinkie has to “tuck” under to reach the Z. The exercises include the following sequences:

Shift Key (Broken Down Into Small Pieces Then Practiced With 123 Step as a Group)

dD dD

kK kK

dD kK/?

1!

[3] The next set of exercises is the pointer partners at step 710. The pointer partner exercise introduces the concept that the pointer finger of each hand must be used to key two staircases. The left pointer finger must key staircases VFR and BGT, while the right pointer finger must key staircases NHY and MJU. The exercise for the pointer partners, designed to teach the letter combinations, RT, FG, VB, UY, JH and MN, include the following sequences:

Pointer Partners

(1) fg fg mn mn

(2) vb fg rt mn jh uy

(3) fg rt tr gr br mn uy my

[4] The next orientation exercises at step 708 are the staircases. As shown by the arrows in FIG. 2A, staircases are formed by the letters ZAQ for the pinkie finger of the left hand, letters XSW for the ring finger of the left hand, letters CDE for the middle finger of the left hand, and letters VFR and BGT for the pointer finger of the left hand. The staircases for the right hand consist of keys /; P for the pinkie finger, keys .LO for the ring finger, keys, KI for the middle finger and letters MJU and NHY for the pointer finger. The thumbs from each hand are used for the space bar.

The exercises designed to teach the staircases as described above require that each finger work its own staircase. To avoid finger and wrist stress, the staircases should be keyboarded as a move from the shoulder. The wrists should float freely so that the arm/hand/finger moves in an aligned diagonal move across the column angle of the keyboard (see FIG. 2A). Each pointer finger has exercises designed for its own staircase (VFR for left pointer and MJU for right pointer) and the staircase is adjacent to it, called pointer partners (BGT for left pointer and NHY for right pointer). The exercises are designed to teach that the letters C, D and E as a staircase. They include the following full keyboard sequences:

Left Pinkie zaq

Left Ring xsw

Left Middle cde

Left Pointer vfr bgt

Right Pointer nhy mju

Right Middle ,ki

Right Ring .lo

Right Pinkie /;p

CDE (“AS”) is the simplest level and most used letter pattern for this particular exercise. Users return to the exercises to review and try harder ones, and in this case to keyboard all the staircases in sequence.

Staircases

(1) cde cde cde cde

(2) zaq xsw cde vfr

(3) zaq xsw cde vfr bgt nhy mju ,ki lo /;p

AB

(1) zzz aaa bbb ab ab

(2) za zaa aaa bbb bbb ab ab ab

(3) zaa aaa bbb zab aaa bbb ab ab

[5] The orientation exercise module next continues at step 712 by instructing the user to keyboard the combination of previous left-handed (or left side) alphabet sequences A to G (“AS”). All of these keys are depressed with the fingers of the left hand.

Alphabet A-G

(1) ab ab cde fg fg

(2) abcde abcde fg fg

(3) abcdefg abcdefg

The alphabet A to G may also be taught in conjunction with the following poem to help the user better remember the proper keyboarding:

| Poem Mnemonic: | Rap Mnemonic: |
|---|---|
| Pinkie A, Stretch Pointer B | A, Stretch B |
| Middle Staircase CDE | Middle CDE |
| Pointer Partners F and G | Partners F and G |

This exercise also teaches correct return of the left-hand middle finger to the D center, as it is necessary to move away from the center to key the letter B.

[6] The next exercise, called line patterns, is shown at step 714. The line patterns exercise includes words and patterns that contain letters that appear in a side-by-side sequence. These are keyed like a piano scale with a different finger for each key. In addition, the numbers and the hyphen key are also learned at this point. The exercises, designed to teach the letters O, P, J, K and L which are also alphabet sequences (“AS”), include the following sequences:

Line Patterns

(1) we were as pop jkl

(2) we ere were as as op pop jkl

(3) we ew as oop pop ere were jkl

Numbers

(1) 1234-56-789-10

(2) 1234-56-789-10 56 10

(3) 1234-56-789-10 56 1234 10

[7] The next series of exercises, called neighbors at step 716, are designed to teach the bilateral nature of the keyboard. The right and left pointer fingers should not move to keys on the opposite side of the keyboard. The patterns in these exercises are keyed with both pointers. These exercises also introduce the transition from the left to the right hand for keyboarding the entire alphabet. The combination BY is taught here to establish the concept that there are only two big stretches on the keyboard, namely the B and the Y, which are easily confused with the UV staircase movement. The users are instructed to move in the shoulder to reach the B and Y, and not to make an awkward move with the hands or body. The exercises, designed to introduce the alphabet sequence GH (“AS”), include the following sequences which include the apostrophe:

Neighbors 1

(3) gh th ty by nt n't

(2) gh ty th nt by gy ng n't

(3) gh ty th nt n't by gy ng gh th

Punctuation is introduced in this orientation exercise as part of meaningful patterns. Since the use of the Pinkie for Return, Tab, Delete, capitalization etc. is introduced first, punctuation follows naturally. The apostrophe is introduced with the “neighbors” exercise since N′T is a frequent spelling pattern. The hyphen is introduced with the numbers in the previous line pattern exercise as a way to break up the number line to introduce the number neighbors 5 and 6.

[8] The next series of exercises 718 is designed to establish that the H is keyboarded with the right pointer finger moving into the center and that the middle finger must return to the center K before moving up to the I key. The exercises teach the letters H and I, which are also alphabet sequences and include the following sequences:

HI

(3) jh jh hi hi hi

(2) jh ki jh ki hi hi

(3) jh jh jh hhh ,ki ,ki iii hi hi hi

[9] The orientation exercise module 700 according to the present invention continues at step 720 by instructing the user to keyboard the previously taught right-handed alphabet sequences from H to P. All of these keys are depressed with the fingers of the right hand. For this set of exercises it is necessary to move the right pointer finger under in a diagonal direction to key M and then move to the center to key N:

Alphabet H-P

(3) hi hi jkl jkl mn mn op op

(2) hijkl mnop hijldmn op

(3) hijklmnop hijklmnop

The following poem may be used in conjunction with the H to P alphabet

| exercise :Poem Mnemonic: | Rap Mnemonic: |
|---|---|
| Neighbor H, up I | H up I |
| JKL in a line | JKL in a line |
| Partners M and N | Partners M and N |
| Ring up O and then | Ring up O and then P |
| Pinkie P | |

[10] A next series of exercises 722 is designed to teach users both to discriminate between the right and left hands and to discriminate between keying the middle finger CDE staircase and the multi-finger line JIL. The exercises, which begin the process of user integration of the left and right hands and reinforce the alphabet sequences CDE and JKL, include the following sequences:

CDE JKL Centers

(3) ddd cde kkk jkl

(2) d cde d cde k jkl k jkl

(3) cde jld cde jkl cde jkl cde jkl

[11] At step 738, the A-P alphabet sequence is repeated. This is a review and integration of both sides of the keyboard.

Alphabet A-P

(3) fg fg mn mn ab ab hi hi

(2) ab cde fg hi jkl mn

(3) abcdefghijklmnop

The combined poem from alphabet A to G and alphabet H to P may be used in conjunction with this exercise.

[12] The next exercise at step 740, called Swinging Pinkies, addresses the combination of the shortest finger, the pinkie finger, in conjunction with the angle of the keyboard. To avoid awkward movements, such as sticking the elbows out and kinking the wrists, the user is taught the “in the shoulder” move. The exercises teach the letters P and Q which are alphabet sequences and reinforces Z, include the following sequences:

Swinging Pinkies

(3) zaq /;p pq pq 10

(2) zaq /;p zp zap pq pq 10

(3) zaq /;p zp zap pq pq zap pq 10

[13] The next exercise, RST 742, combines the pointer finger partners RT with the ‘slow’ ring finger for S. The exercise teaches the letters and alphabet sequence R S T and includes the following sequences:

RSTUV

(1) rt rst uv uv

(2) rt sss rst uuu vvv uv uv rstuv

(3) rt rt sss sss rst rst uv rstuv

[14] The next exercise at step 744, called the Up U Down V, utilizes the parallel motion of the UV alphabetic sequence to teach the diagonal slope of the keyboard. The exercise both reinforces the alphabet and teaches the letters U and V. It also reinforces the up and down motion in the shoulder as well as the alphabetic sequence. The BY stretches are repeated in order to teach discrimination of a simple up and down the staircase movement versus a partner stretch. They include the following sequences:

UV and BY

uuu vvv bbb yyy uv by

uv uv uv by by by uv by

nun bbb yyy vvv uv uv by by

[15] The next exercise called the Weak Ring Finger 724, draws attention to the need to work with the ring finger. The ring finger presents an important problem. The middle and ring finger of each hand share tendons and nerves, resulting in confused signals from the brain to the fingers during the early learning phases of keyboarding. Because the ring finger does not move easily or respond to brain signals as readily as the other fingers, the user often compensates by making awkward body movements that can lead to repetitive stress injury. In fact, contrary to the user's perception that the ring finger is inherently weak, poor individuation causes the problem. These exercises include teaching the letters W SX, emphasizing the alphabet sequence WX and introducing O “.” and the concomitant need to practice moving the ring down to the “.” without looking at that key. The exercises include the following sequences:

Weak Ring Finger 1

(1) xsw wx .lo o. wx wx

(2) xsw wx .lo o. loss so oxo wow

(3) wx wx o. o. so slow loss wool

[16] The next exercise, known as the ring pinkie combination 728 teaches how to use the ring and pinkie fingers in combination. The typing exercise for this combination is as follows:

Ring Pinkie Combo 1

(1) was swap paws wasp pool

(2) pow zoo pals slap oops paw

(3) lap slap pal pals opals sloop

[17] The YZ key combination and alphabet sequence is taught at step 726. The user's attention is drawn to the fact that the left pinkie has to “tuck” under to reach the Z, a concept first introduced when teaching Shift. Additionally, the concept of the user moving from the shoulder to reach the Y is reinforced. The exercise teaches the letters Y and Z. It reinforces the alphabet sequence YZ and includes the following sequences:

YZ

(1) yyy zzz yz

(2) uy nhy za zaq yz

(3) uv zy vu yz uv by yz

[18] The orientation exercises continue by reinforcing the last half of the alphabet from P to Z at step 730.

Alphabet P-Z

(1) pq pq rst rst uv uv wx wx yz yz

(2) pqrst uvwx yz

(3) pqrstuvwxyz pqrstuvwxyz

At step 732, the following poem may be used in conjunction with the exercise consisting of the sequence of letters from P to Z:

| Poem Mnemonic: | Rap Mnemonic: |
|---|---|
| Swing up Pinkies P and Q | Pinkies P and Q |
| Slow R S T, and up to U | RST, up U |
| Left Pointer down to V and next | Down V and next |
| Ring-up W, glide down X | Ring up W, down X |
| Stretch right pointer Y, | Stretch Y, under Z |
| Pinkie under for Z. | It's easy you see! |
| Keyboarding's as easy as ABC! | |

[18] Upon completion of the exercises, the user has been introduced to every key [true?] on the keyboard. Thus, the entire alphabet on the keyboard can be learned in short time as compared to prior methods such as the Home Row.

Continuous Alphabet:

abcdefghijklmnopqrstuvwxyz

In conjunction with keyboarding the entire alphabet, one of the following poems or songs may be used by the user to help build [muscle memory] skills:

Alphabet Song (Sung to the Tune of Twinkle Twinkle Little Star):

Pinkie A, stretch Pointer B

Middle staircase CDE

Pointer partners F and G

Right hand says, “Now time for me!”

Pointer Neighbor H writes “hi”

By stepping Middle up to I

Back to Middle makes it fine.

Play J K L all in a line

Pointer Partners M and N

Ring finger up to O and then

Swing up Pinkies P and Q

Slow and steady see you through

Pointers R, S, partner T.

Up for U and down to V

Left ring finger staircase next

Hop up to W down to X

Right Pointer Y, Pinkie under for Z

Keyboarding's as easy as ABC

Alphabet Rap

A stretch B,

Middle CDE

Partners F and G

Neighbor H, Up I,

J K L in a line

Partners M and N

Ring-up O . . . and then

P and Q

R S T, up U

Down V and next

Ring-up W, Down X

Stretch Y, Under Z

It's easy for me!

Alphabet Poem:

Pinkie A, stretch Pointer B

Middle Staircase CDE

Pointer Partners F and G

Neighbor H, then Middle-up I,

Play JKL all in a line

Down Pointer Partners M and N

Ring finger up to O . . . and then

Swing up Pinkies P and Q

Slow RST, and up to U

Left Pointer down to V and next

Ring up W, glide down to X

Stretch Pointer Y,

And under for Z.

Keyboarding's as easy as ABC

The next exercise involves the generation of simple words. In particular this exercise takes the patterns already learned and incorporates them into frequently used words. Those words can include, but are not limited to “there, here, where, wow, etc. This technique introduces two, three and four letter words that facilitate generative writing.

At step 736, the generative writing/free writing portion of the orientation exercises is activated. In this part of the exercises the user generates an original thought or expands upon short phrases into complex sentences. As a result the user experiences the sense of talking through their fingers and a sense of automatic finger response.

Introductory Session One—Left Side A to G:

This session isolates a,b,c,d,e,f,g. It emphasizes that the Middle finger is used for c and that the ce ec and ed patterns are understood as part of the CDE staircase. It also introduces line patterns and words, add dad.

Left Side A-G:

Ed de ce ec ad add dad eg beg egg ge

Introductory Session Two—Left Side A to G+RSWZ:

This session addresses the Ring Middle Pinkie confusion through the was and saw triangle and introduces R through the red, dered triangle. The ere and were patterns were covered in the Orientation. Z is also included in some of the sentences and copy practice and will appears in all the following sessions.

Left Side W, S and R:

Was saw ere were rew ered red deer Fred dress

Introductory Session Three—Right Side H to P+YO (no I):

This session works the Ring & Pinkie fingers through pool, loop & polo triangles, and the Middle and Ring fingers through the look ook triangle. Y is also introduced. It targets the natural tendency to move the Ring finger to move straight up to P, rather the Pinkie gliding diagonally up so that the Ring works O. Since O and I work the easily confused Ring and Middle fingers, only O (i is omitted) is presented at this stage. It is also because capital i is often confused with lower case L when a non seraph font is used such as this e.g.: 1 & I.

Right Side O and Y:

Ly ny only op pop poppy loop polo pool ook look olk

Introductory Session Four—Right Side H to P+I (i no o):

This session continues the right hand focus to preempt the confusion that exists when discriminating the Ring finger for O and Middle finger for I. Likewise the Pointer Partners M and N are often a cause of both fingering and phonetic error.

Right Side I and M:

Im him lip hip ill Jill ilk kill I ice iz hy why ay my

Introductory Session Five —Right Side H to P+Y

This session focuses on N rather than M while i and O are presented in combination. The idea here is to integrate the use of both hands while being aware of the Pointer Partner and Ring/Middle issues.

Right Side I O and N:

On onk oon in ink kink ing king oin join ion lion onion

After this lesson, additional practice and integration for real writing may be gained from completing some or all of the phrases in the “Sentence Expansions” exercises.

Introductory Session Six—Both Sides+QTUVX:

This session targets and integrates Q U V T X which have only been practiced in the context of the alphabet at the beginning of each of the previous Introductory Sessions. It presents T as the Partner of R. Likewise, U is the Pointer key belonging to the already established Partner Y. Simply move the right Pointer up its staircase to U. The left Pointer slips down its staircase to V. Q and U are always part of a pattern and often followed by I as in quit, quiet and quick. Just as X is a gliding down motion as in WX and the right Ring period, when it is part of a word, X must be made with the same in the shoulder diagonal motion.

Both Sides Q U V Z T:

Qui quiz ium mum mug gum but never ever even every wax sax

Introductory Session Seven—Both Sides RT:

This session targets a frequent fingering error pattern when R and T appear in conjunction with E in words such as street, tree etc. It is tempting, when making tr or stre or ert, to use the Middle and Pointer for the Pointer Partners R and T.

Both Sides Pointer T and R:

Rt try rty ert ter tree ex tra str street New address

Introductory Session Eight—Both Side Combos

This session works with patterns and words made up from combinations that use alternating hands. It continues to work with the Pointer Partners R & T and U & Y while also integrating Neighbor patterns such as gh, ty, th, nt and ng. Frequent Odemon¹ spelling patterns, ight , eight , eith are also incorporated in this session.

Neighbors B N G H T Y:

Ber ered bered ty nt ng gh ght ur ure ture true

Introductory Session Nine—Whole Keyboard

This session focuses on integrating the two Middle fingers in frequent spelling patterns such as ine , ike , ide , ake , ind , ick, ick, ack , friend etc. I & E are often confused by people who easily mirror the sides of their body and who have difficulty telling right from left. As fluency starts to build naturally, these errors emerge as reversals.

Combos and Apostrophe N'T I'VE:

Ick eck ch itch nd find ine ive I've nt n't

Introductory Session Ten—Whole Keyboard and Staircases

This session integrates the staircase configuration as it appears in parts of words and the necessity to move from the shoulder when making awkward moves. Words such as decided, jump and mummy contain the diagonal up and down motion of the angle of the keyboard staircases. R & T Pointer Partners and teh QU pattern within words are reinforced. Z and X are incorporated in many words to provide the necessary practice to automate these less frequent letters.

Staircases MJU ZAQ LO:

Saz zas uz iz oz ix ox urn jump mummy hy oil ou illion

Introductory Session Eleven—Middle Line+I(i)

This session focuses upon words that use mostly the ASDFGHJKL line, known as the “Home Row” in most typing programs. Becoming automatic in this middle line is necessary and often a problem for those that continue to look at their hands, since the fingers cover the letters/keys. I is included to permit a wider variety of words and sentences.

Middle Row and I:

Sass sash ad dad aid al All fl il fill ig ing gin

Introductory Session Twelve—Middle LIne+E

This session focuses upon words that use mostly the ASDFGHJKL line, known as the ³Home Row² in most typing programs. Becoming automatic in this middle line is necessary and often a problem for those that continue to look at their hands, since the fingers cover the letters/keys. E is included to permit a wider variety of words and sentences.

Middle Row and E:

Ead eaf ade he she eak ake ness ese These eel eal le

The sentences are less colorful and have a contrived feel. This is what you have been spared by doing my course! I have tried to make it more interesting incorporating i (and E in the next lesson). Now that you have learned not to anchor on this middle line, but to use your D and K centers as a way of “coming home”, it is ok to practice this as an exercise. Become really fluent by feel with these letters. If you find an edutainment typing tutor motivating, you could do the beginning lessons that teach this “home row”. Now that you have learned not to anchor on this middle line, but to use your D and K centers as a way of “coming home”, it is ok to practice this as an exercise. Become really fluent by feel with these letters. If you find an edutainment typing tutor motivating, you could do the beginning lessons that teach this “home row”.

While the invention has been described with respect to teaching keyboarding using both the right and left hands, the method is not so limited and may be used equally well to teach keyboarding using only a single hand.

For example, if only the right hand is going to be used for keyboarding, the pointer, middle, ring and pinkie fingers are centered over the F, G, H and J keys respectively. The series of exercises are similar as to the two handed operation, except for differences used to compensate for the lack of the left hand fingers. A poem that may be used in conjunction with the entire alphabet for a right-hand only user is as follows:

Pointer A, down Middle finger B

Up Pointer Staircase CDE

Pointer F and Middle G

Right Side says, “Now time for me.”

Ring finger H, then Pinkie-up I,

Hop Pinkie JKL in a line.

Down Pinkie-Ring M and N,

Stretch Pinkie up to O . . . and then

Swing Pinkie P and Pointer Q

Slow and Steady Sees You Through

Pointer R, S Middle T,

Up Pinkie U, down Pinter V

XSW staircase next

Reach Pointer W, hop down to X

Ring Finger Y, Stretch Pointer to Z.

Keyboarding's as easy as ABC!

Similarly, if only the left hand is going to be used for keyboarding, the pointer, middle, ring and pinkie fingers are centered over the J, H, G and F keys respectively. The series of exercises is similar to the two handed operation, except for differences used to compensate for the lack of the right hand fingers. A poem that may be used in conjunction with the entire alphabet for a left-hand only user is as follows:

Pinkie A, down Ring finger B

Up Pinkie Staircase CDE

Pinkie F and ring G

Right side says, “Now time for me.”

Middle H, then Pointer-up I,

Hop Pointer JKL in a line.

Down Pointer-Middle M and N,

Stretch Pointer up to O . . . and then

Swing Pointer P and Pinkie Q

Slow and steady sees you through

Pinkie R, S Ring finger T,

Up pointer U, down Pinkie V

XSW staircase next

Reach Pinkie W, jump down to X

Middle up Y, stretch Pinkie Z.

Keyboarding's as easy as ABC!

The method as described above may be implemented in a general-purpose computer or word processor device. As shown, a user can be lead through the series of exercises described above by having the software prompt the user to follow the letter sequences and keyboard them in at a certain rate. Feedback could be provided in the form of messages displayed on the screen indicating, for example, the number of errors, speed of keyboarding, praise for proper completion of the sequence, etc. By utilizing the method of the present invention embodied in interactive software, a user is afforded the opportunity for self-study without the need for a teacher or coach. Reference has been made to a preferred embodiment in describing the invention. However, those skilled in the art and familiar with the disclosure of the invention may implement additions, deletions, substitutions, or other modifications which would fall within the scope of the invention defined in the claims without departing from the spirit or scope of the invention. Also, the invention may be implemented in software with programmed processors and controllers to provide self-teaching or used in conjunction with a teacher or coach. All are deemed equivalent with respect to the operation of the invention. 1067123

What is claimed as new and desired to be protected by Letters Patent of the United States is:

1. A method of teaching a user keyboarding on a keyboard comprising a plurality of keys, each of said plurality of keys being located in a respective position on said keyboard, said method comprising the steps of:
Familiarizing the user with the respective location of each of said plurality of keys on said keyboard;
Instructing the user to learn to keyboard a first set of said plurality of keys; and
Instructing the user to learn a second set of said plurality of keys on said keyboard utilizing a specific series of short exercises reflecting said keyboard organization, frequent spelling combinations, and alphabet parts.

2. The method according to claim 1, wherein the reinforcement of alphabet parts creates a motivation for the user to achieve the same mechanical fluency for typing as verbal fluency for reciting the alphabet.

3. The method according to claim 1, wherein said first set of said plurality of keys includes function keys.

4. The method according to claim 2, wherein said function keys include space, shift, return, tab and delete keys.

5. The method according to claim 2, wherein said second set of keys includes alphabet keys and numbers keys.

6. The method according to claim 4, wherein said specific series of short exercises includes alphabet keys d and k.

7. The method according to claim 5, wherein said second set of keys includes at least one punctuation key.

8. The method according to claim 6, wherein said specific series of short exercises includes at least one punctuation key.

9. The method according to claim 7, wherein said specific series of short exercises includes alphabet keys d and k, punctuation keys /, !, and ?, and number key 1.

10. The method according to claim 6, wherein each of said keys in said second set is grouped in a staircase with two other keys in said second set.

11. The method according to claim 9, wherein said specific series of short exercises includes at least one staircase.

12. The method according to claim 10, wherein said at least one staircase is selected from the group consisting of keys zaq, xsw, cde, bgt, nhy, mju, ,ki, .lo, /;p.

13. The method according to claim 10, wherein said specific series of short exercises includes alphabet keys a to g.

14. The method according to claim 10, wherein said specific series of short exercises includes words and patterns that contain letters that are side-by-side on said keyboard.

15. The method according to claim 13, wherein said specific series of short exercises includes alphabet letters b, y, g and h.

16. The method according to claim 14, wherein said specific series of short exercises includes alphabet keys h to p.

17. The method according to claim 15, wherein said specific series of short exercises includes alphabet keys c, d, e, j, k and 1.

18. The method according to claim 16, wherein said specific series of short exercises includes alphabet keys a to p.

19. The method according to claim 17, wherein said specific series of short exercises includes alphabet letters p and q.

20. The method according to claim 18, wherein said specific series of short exercises includes alphabet letters r, s and t.

21. The method according to claim 19, wherein said specific series of short exercises includes alphabet letters u and v.

22. The method according to claim 20, wherein said specific series of short exercises includes alphabet letters w and x.

23. The method according to claim 21, wherein said specific series of short exercises includes alphabet letters y and z.

24. The method according to claim 22, wherein said specific series of short exercises includes alphabet letters a to z accompanies by a specific poem.

25. The method according to claim 22, wherein said specific series of short exercises includes alphabet letters a to z accompanies by a specific song.

26. The method according to claim 22, wherein said specific series of short exercises includes alphabet letters a to z accompanies by a specific rap song.

27. The method according to claim 22, further comprising:
Color coding each of said plurality of keys on said keyboard; and
Color coding each finger of said user with a color corresponding to a key for which a respective finger is used.

28. The method according to claim 26, wherein said step of color coding each of said plurality of keys further includes:
Placing one of a plurality of self-adhesive color-coded keycaps on a respective one of said plurality of keys.

29. The method according to claim 27, wherein at least one of said plurality of self-adhesive color- coded keycaps is provided with texture.

30. The method according to claim 27, wherein the step of color coding each finger of said user further includes:
Placing one of a plurality of self-adhesive color-coded stickers on a respective finger.

31. A computer readable storage medium containing a computer readable code for operating a computer to perform a method of teaching a user keyboarding on a keyboard comprising a plurality of keys, each of said plurality of keys being located in a respective position on said keyboard, said method comprising the steps of:
Familiarizing the user with the respective location of each of said plurality of keys on said keyboard;
Instructing the user to learn to keyboard a first set of said plurality of keys; and
Instructing the user to learn a second set of said plurality of keys on said keyboard utilizing a specific series of short exercises reflecting said keyboard organization, frequent spelling combinations, and alphabet parts.

32. The computer readable storage medium according to claim 30, wherein said first set of said plurality of keys includes function keys.

33. The computer readable storage medium according to claim 31, wherein said function keys include space, shift, return, tab and delete keys.

34. The computer readable storage medium according to claim 31, wherein said second set of keys includes alphabet keys and numbers keys.

35. The computer readable storage medium according to claim 33, wherein said specific series of short exercises includes alphabet keys d and k.

36. The computer readable storage medium according to claim 34, wherein said second set of keys includes at least one punctuation key.

37. The computer readable storage medium according to claim 35, wherein said specific series of short exercises includes at least one punctuation key.

38. The computer readable storage medium according to claim 36, wherein said specific series of short exercises includes alphabet keys d and k, punctuation keys /, !, and ?, and number key 1.

39. The computer readable storage medium according to claim 35, wherein each of said keys in said second set is grouped in a staircase with two other keys in said second set.

40. The computer readable storage medium according to claim 38, wherein said specific series of short exercises includes at least one staircase.

41. The computer readable storage medium according to claim 39, wherein said at least one staircase is selected from the group consisting of keys zaq, xsw, cde, bgt, nhy, mju, ,ki, .lo, /;p.

42. The computer readable storage medium according to claim 39, wherein said specific series of short exercises includes alphabet keys a to g.

43. The computer readable storage medium according to claim 39, wherein said specific series of short exercises includes words and patterns that contain letters that are side-by-side on said keyboard.

44. The computer readable storage medium according to claim 42, wherein said specific series of short exercises includes alphabet letters b, y, g and h.

45. The computer readable storage medium according to claim 43, wherein said specific series of short exercises includes alphabet keys h to p.

46. The computer readable storage medium according to claim 44, wherein said specific series of short exercises includes alphabet keys c, d, e, j, k and 1.

47. The computer readable storage medium according to claim 45, wherein said specific series of short exercises includes alphabet keys a to p.

48. The computer readable storage medium according to claim 46, wherein said specific series of short exercises includes alphabet letters p and q.

49. The computer readable storage medium according to claim 47, wherein said specific series of short exercises includes alphabet letters r, s and t.

50. The computer readable storage medium according to claim 48, wherein said specific series of short exercises includes alphabet letters u and v.

51. The computer readable storage medium according to claim 49, wherein said specific series of short exercises includes alphabet letters w and x.

52. The computer readable storage medium according to claim 50, wherein said specific series of short exercises includes alphabet letters y and z.

53. The computer readable storage medium according to claim 51, wherein said specific series of short exercises includes alphabet letters a to z accompanies by a specific poem.

54. The computer readable storage medium according to claim 51, wherein said specific series of short exercises includes alphabet letters a to z accompanies by a specific song.

55. The computer readable storage medium according to claim 51, wherein said specific series of short exercises includes alphabet letters a to z accompanies by a specific rap song.
